(19) United States
(12) Patent Application Publication
(10) Pub. No.: US 2002/0178060 A1
(43) Pub. Date: Nov. 28, 2002

(54) System and method for providing and redeeming electronic paperless coupons

(76) Inventor: Patrick M. Sheehan, Jamison, PA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/154,337

(22) Filed: May 22, 2002

Related U.S. Application Data
(60) Provisional application No. 60/293,721, filed on May 25, 2001.

(51) Int. Cl. G06F 17/60

(52) U.S. Cl. 705/14

(57) ABSTRACT

A system and method for providing and redeeming electronic paperless coupons. Electronic coupons in accordance with the present invention are typically generated by a content or online services provider and retrieved by a consumer. In one embodiment, the electronic coupon may be embedded in a video or audio program received and enjoyed by the consumer, while in another embodiment, the coupon may be transmitted via a separate signal. A variety of devices, including televisions, set-top boxes, personal computers (PCs), and so forth may be used to request, receive, and/or redeem electronic coupons. Electronic coupons may be transmitted across a packet switched network, the Internet, an intranet, a local area network, a circuit switched network, a landline based telephone system, dedicated fiber-optic lines, a cellular network, a combination circuit switched and packet switched network, and/or any other type of network capable of transmitting information.

### CROSS REFERENCE TO RELATED APPLICATIONS

This application claims priority to U.S. Provisional Application Serial No. 60/293,721, entitled “System and Method for Providing and Redeeming Electronic Paperless Store Coupons” and accordingly claims the benefit of that application's filing date for such matter as is disclosed therein, which is in turn incorporated herein by reference in its entirety. This application also incorporates by reference: U.S. Pat. No. 6,233,736, issued on May 15, 2001 and entitled “Media Online Service Access System and Method,” U.S. Pat. No. 5,774,664, issued Jun. 30, 1998 and entitled “Enhanced Video Programming System and Method for Incorporating and Displaying Retrieved Integrated Internet Information Segments.” Jack D. Hidary et. al., inventors; U.S. Pat. No. 6,018,768, issued Jan. 25, 2000 and entitled “Enhanced Video Programming System and Method for Incorporating and Displaying Retrieved Integrated Internet Information Segments,” Craig Ullman et. al., inventors; and U.S. Pat. No. 5,778,181, issued Jul. 7, 1998 and entitled “Enhanced Video Programming System and Method for Incorporating and Displaying Retrieved Integrated Internet Information Segments,” Jack D. Hidary et. al., inventors.

### BACKGROUND OF THE INVENTION

Today, many consumers use traditional paper coupons to receive discounts on products or services. This practice has existed for decades. These coupons are often delivered to a consumer in a newspaper, postal mailing, or at the time of purchase of another product or service. Besides the obvious advantage to the consumer of saving money, coupons also provide advertising for a company's products/services and may provide a manufacturer or retailer with a new consumer who wishes to take advantage of the coupon. However, many consumers fail to take advantage of coupons, because the coupons are inconvenient, easy to lose or damage, and in many cases, simply not worth the effort of collecting, bringing to the store, and redeeming.

Consumers often avoid coupons because they are inconvenient to use. First, the consumer usually has to cut the coupons out of a newspaper advertisement or similarly collect the coupons. A large collection of paper coupons will often be quite bulky, and many consumers carry a special coupon holder that can be relatively large and heavy. Many consumers do not use coupons for this very reason, since they do not want to carry around such a large item. Consumers also often forget to bring coupons with them to the store and thus cannot redeem them, resulting in a missed opportunity for consumer savings and a sale for the store and manufacturer. A consumer could even purchase something without realizing that he or she had a coupon for the item, because of the sheer bulk of coupons that they have collected. In addition, paper coupons are easy to lose, either at home, while traveling to the store, or even while shopping.

Traditional paper coupons also fail to take full advantage of technical capabilities in tracking purchases. It is often difficult to track the purchases an individual consumer may make and it is also difficult, if not impossible, to track the purchasing patterns of large groups of consumers using coupons. Moreover, it is difficult to customize traditional coupons based on individual demographics, purchasing patterns, and other factors which retailers or manufacturers may desire to incorporate into an individualized coupon.

Yet another disadvantage of traditional coupons is that expired coupons may be redeemed because it is often difficult or inconvenient to confirm that a coupon is still valid. This causes problems for retailers and manufacturers, because they lose certainty about when coupons will be redeemed.

Another disadvantage of traditional coupons is the inability to realize synergy between television, the Internet, and the myriad advantages and possibilities of coupons. Traditional coupons, usually distributed along with a paper media such as newspapers, cannot be customized based on the program being televised or the Web page being viewed. Similarly, traditional coupons cannot be based on a viewing pattern (either of television programs, Web pages, or a combination of both) or on a viewer's inputs in reaction to, for example, an advertisement.

### SUMMARY OF THE INVENTION

Systems consistent with the present invention provide consumers with an easy-to-use electronic coupons that can be related to video or audio programming or advertisements. Such systems also provide the ability for retailers, service providers and manufacturers to provide electronic coupons customized for each user or group of users, while also allowing the use of the coupons to be easily tracked.

A programming content creator, such as a television network, local television affiliate or radio station, could embed the appropriate coupon signal within the video or audio broadcast, whether it be regular programming or an advertisement. The coupon-enabled signal could also be transmitted to users independently from the video or audio broadcast, such as by an Internet connection over a wireless network or other communications mediums.

The consumer can receive the video or audio program and coupon-enabled signal at a set top box coupled to and/or provided with a television, personal computer (PC), personal digital assistant (PDA), wireless device, telephone, remote control, game console, World Wide Web enabled telephone (web phone), web tablet, or other device (hereinafter, collectively referred to as a “client device”). The client device may provide the consumer with an indication that an electronic coupon is available. This indication can be in any form, and can range from an auditory queue (e.g., beep, buzz, or spoken word) to a visual indication (e.g., a light on the television turning on, a coupon symbol appearing on the corner of the television screen, a picture-in-picture screen, or pop-up window on a browser), to a tactile signal (e.g., a vibration or a similar motion).

When the consumer sees the electronic coupon indication, the consumer may request the electronic coupon. In one embodiment, the consumer simply actuates an electronic coupon button located on a remote control associated with the client device. The request is received by the client device for processing or further transmission. Other request mechanisms are available, such as clicking a mouse button, pressing a button on a presentation device, or voice activation.

Alternatively, electronic coupons can be automatically granted without user interaction. For example, an electronic coupon can be granted for watching an entire program or advertisement. If an electronic coupon is automatically granted, there is no need to give the consumer any indication that an electronic coupon is even available.

When a request for an electronic coupon is received by the client device (or a coupon is automatically granted), the client device can process the request in a variety of ways. One way of processing the electronic coupon is to transmit the appropriate electronic coupon information to a cable head-end or web server operations center for processing. The operations center sends the electronic coupon information to a separate back-end system accessible by retailers to confirm an electronic coupon. When the consumer enters the retail establishment, the retailer contacts the back-end system to confirm the coupon. It is to be appreciated that such contact may be manual, semi-automatic, and/or automatic and may utilize any level of automatic and/or human interaction desired. Alternatively, the client device could transmit the coupon information directly to a back end system, without using a cable head-end or web server operations center.

In another embodiment, the electronic coupon may be tied into an account associated with a club card utilized by the consumer. In such an embodiment, information is provided at either the head-end or the client device identifying the consumer's club card account number and such electronic coupons are then forwarded to such account for redemption by the consumer upon the next “swiping” of their club card, for example, at a check-out register. In this manner, the electronic coupon is automatically associated with the consumer's account, and additional consumer actions are not required to utilize or redeem the electronic coupon. It is to be appreciated that utilizing such a system would provide enormous benefits to retailers and manufacturers/distributors as the mechanism for redeeming and processing an electronic coupon (i.e., the club card and associated hardware) is already established. Such an embodiment would provide retailers/manufacturers/distributors with an efficient to utilize and an additional avenue for marketing and promoting their goods/services.

In another embodiment, the client device embeds the electronic coupon onto a smart card or similar storage device. It is to be appreciated that the storage device may be separate from (e.g., portable) and/or provided with the client device. This embodiment allows all or a significant number of a consumer's electronic coupons to be stored on a smart card or other storage device. The consumer could simply use the smart card or storage device to redeem the coupons whenever a purchase is made.

In another embodiment, the consumer could be watching video programming on a television along with associated online content on a computer, PDA, or other wireless device screen. When an electronic coupon is selected via, for example, a mouse click on a computer, the electronic coupon request may be sent directly to a back-end service using, for example, an Internet connection. This embodiment may eliminate the need for a client device and/or a head-end system.

Similarly, in another embodiment, wireless devices (e.g., wireless telephone, PDAs, pagers, and web tablets) are used to request, retrieve and/or redeem or store electronic coupons via wireless communication links. It is to be appreciated that such wireless links may utilize the Internet and/or similar networks. This embodiment eliminates the need for a physical transmission link between the client device and the online provider or content creator. Similarly, a wireless device may also be utilized by merchants to redeem coupons, verify coupons, and perform similar functions.

Electronic coupons provide the potential to benefit from the synergy between video or audio programs and the Internet. Electronic coupons can be customized based on the program a consumer is watching or hearing, a Web page the viewer is accessing, or a combination thereof. A consumer's user profile can be based on both the consumer's television history and Internet history. Moreover, electronic coupons can be requested by an Internet-based system or by a television-based system. One example of the synergy between electronic coupons, television, and the Internet is based on a two-box embodiment with a television and a browser-enabled client device. The consumer could watch a football game on the television and receive associated advertising or content on a browser on the client device, and the consumer could then receive an indication that an electronic coupon is available. The electronic coupon could be customized based on the televised content (the football game) and the associated advertising (a car dealership)—resulting in, for example, a coupon for a free replica helmet from the local car dealership if the consumer redeems the electronic coupon by test-driving a particular vehicle.

Instead of bulky, troublesome, and generic traditional coupons, electronic coupons can be easily embedded in a smart card or similar device that the consumer always carries with him or her. A smart card could carry essentially an unlimited amount of electronic coupons with no difference in size, and the consumer would not have to remember to find the appropriate coupons each time they went to a store.

Electronic coupons can also be stored on a centralized database accessible by retailers. For example, Wal-Mart could have an electronic coupon database, and whenever a consumer checked out, the electronic coupon database could be checked and the appropriate cost savings implemented.

Another embodiment of the present invention allows consumers to fill out a form on a Web site (associated with a retailer) on the Internet or other online network and receive an electronic coupon for doing so. To redeem the coupon, the consumer would notify the retailer that an electronic coupon was requested and the retailer would confirm that the electronic coupon was available and valid. Alternatively, the electronic coupon could simply be embedded on a smart card or similar device attached to the consumer's client device after the form is completed.

Electronic coupons also save time at the time of checkout and reduce the possibility of error. Instead of having to enter each coupon manually or scan each paper coupon, one swipe of a smart card or one check of a centralized database (performed, perhaps, during a credit check) would allow all appropriate electronic coupons to be processed. Moreover, expired coupons could be automatically detected so that an improper discount would not be obtained.

Electronic coupons can be individualized based on a wide variety of factors, many or all of which could be contained in a user profile. For example, the value of an electronic coupon could be based on demographics, geographic location, viewing history, and previous coupon history. Similarly, the particular retailer, product, and type of electronic coupon can be varied on any available user profile information. Ford, for example, could vary its electronic coupons based on any of these factors. Someone living in Colorado could receive coupons for four-wheel drive SUVs while someone living in Boston would receive a coupon for a small economy car. Moreover, the electronic coupon for the Colorado consumer might only work at select dealerships in the Denver area. If someone was a repeat consumer, for example, they could be given a larger value for the electronic coupon.

### BRIEF DESCRIPTION OF THE DRAWINGS

FIG. 1 is a block and schematic diagram illustrating the online services access system in accordance with the present invention.

FIG. 2 is a block and schematic diagram of an access controller used in the online access system of FIG. 1.

FIG. 3 is a block and schematic diagram of another embodiment of an access controller used with a computer in accordance with the present invention.

FIG. 4 is a block diagram of an embodiment of the present invention utilizing a client device, a coupon-enabled indicator, a head-end system, a back-end system, and a remote control device.

FIG. 5 is a block diagram of an embodiment of the present invention wherein the coupon signal is transmitted independently of any programming signal.

FIG. 6 is a block diagram of an embodiment of the present invention requesting and retrieving an electronic coupon across the Internet.

FIG. 7 is a block diagram of an embodiment of the present invention wherein the presentation device receives both audio/video programming and a coupon signal, colloquially referred to as a “one-box” embodiment.

FIG. 8 is a block diagram of an embodiment of the present invention wherein the presentation device receives audio/video programming while a client device receives a coupon signal, colloquially referred to as a “two-box” embodiment.

FIG. 9 is a block diagram of the system of the present invention utilizing a set top box, a coupon-enabled indicator, a smart card device, and a remote control device.

FIG. 10 is a block diagram illustrating the confirmation of an Internet-based electronic coupon by a retailer.

FIG. 11 is a flow diagram of an embodiment of the present invention requiring the user to fill out a form on a Web page to receive the electronic coupon.

FIG. 12 is a flow diagram of an embodiment of the present invention wherein an electronic coupon is associated with a consumer's club card account with a retailer.

### DETAILED DESCRIPTION

Generally speaking, a system and method for providing and redeeming electronic paperless coupons is provided. Electronic coupons are typically generated by a content or online services provider and retrieved by a consumer. In one embodiment, the electronic coupon may be embedded in a video or audio program by the consumer, while in another embodiment; the coupon may be transmitted via a separate signal. A variety of client devices, including televisions, set-top boxes, personal computers (PCs), personal digital assistants (PDAs), game consoles, World Wide Web enabled telephones (web phones), game consoles, wireless devices, and so forth may be used to request, receive, and redeem electronic coupons. Electronic coupons may be transmitted across various communications mediums including, but not limited to, the Internet, an intranet, a local area network, a landline based telephone system, fiber-optic lines, infrared broadcast, a cellular network, a digital wireless network, a private network, a public network, satellite links, and/or any other type of network communications mediums, and/or combinations thereof capable of transmitting information.

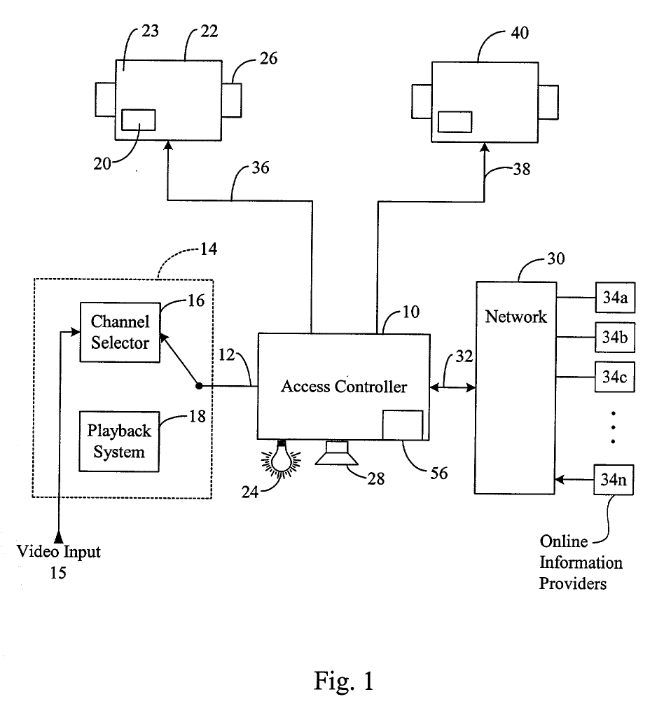

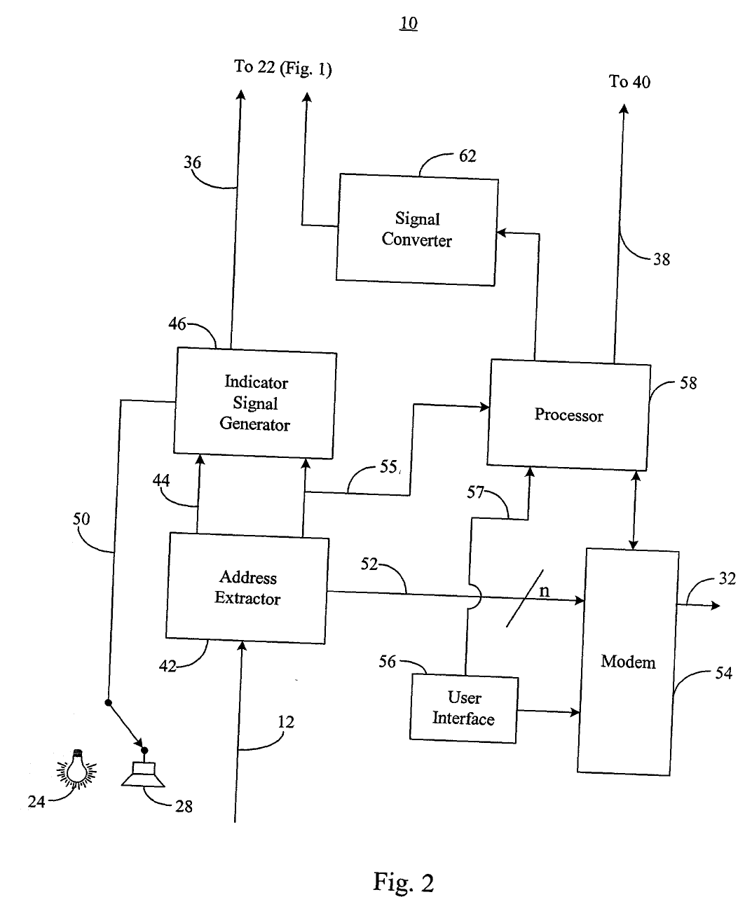

In one embodiment, an online services access system may transmit electronic coupons to a user. An online services access system according to such embodiment is illustrated in FIG. 1. The online services access system includes access controller 10, which incorporates all components necessary to provide online access and to access received online information signals. Access controller 10 is constructed to receive an electronic signal 12 from a broadcast, cable or prerecorded medium program in conventional form from a video signal source 14. Video signal source 14 can be selectively switchable to provide output from a channel selector 16 connected to a cable or broadcast video input 15 or from a video playback system 18 which may be, for example, a videocassette recorder or an analog or digital videodisc device. It will be appreciated that channel selector 16 may be provided in a unit separate from the playback system 18, or within access controller 10 itself. Alternatively, access controller 10 can be constructed to receive and decode program signals at radio frequency as received from a broadcast or cable video source, or as downconverted to baseband by the front end receiving circuitry of a playback system. It will also be appreciated that the function and results provided by access controller 10 are not dependent upon which of many available playback systems is connected thereto, whether such systems are analog or digital in format, or whether such playback systems operate upon videotape, audiotape, or disc media.

The electronic signal 12 may be received by the access controller 10 via any transmission means, including broadcast, cable, satellite, or across the Internet, an Intranet, local access network (LAN), and so forth, and may reside on video servers. Furthermore, the electronic signal 12, with or without embedded address signals or Uniform Resource Locators (URLs), can be encoded on a video home system (VHS), Betamax videotape, digital video disk (DVD) or other recorded or recordable medium.

Access controller 10 is connected via a primary output signal line 36 to a conventional reproducing system 22 such as a television set or LCD screen, and is optionally connected through a second output signal line 38 to a high resolution reproducing system 40, such as a computer monitor, high-definition television (HDTV), plasma screen, and so forth. In addition, access controller 10 is connected to a public or private network 30 through a communications signal carrier 32, such as a telephone line, coaxial cable, fiber optic link, cellular, radiotelephone, or satellite link. Network 30, which may be any private or public local area network (LAN), wide area network (WAN), office network, company network, Internet, Intranet, circuit-switched network, public switched telephone network (PSTN), and so forth, is used to route address and information signals between access controller 10 and at least a selected one of a plurality of online information providers 34a, 34b, 34c . . . 34n. Access controller 10 receives from the online information provider, through network 30, information signals having a video or audio program content and selectively provides, through appropriate conventional processing, a conventional program signal or a high resolution signal for reproduction upon standard reproducing system 22 or high resolution reproducing system 40, respectively.

One embodiment of the internal construction of access controller 10 is described with reference to FIG. 2. Access controller 10 may include an address extractor 42, which receives the electronic signal 12. Address extractor 42 includes hardware and/or software to detect, decode and store an address, which has been embedded in a video or audio program signal. Among the ways, which exist to detect an address signal transmitted in conjunction with an analog video signal, address extractor 42 may be constructed to detect a digital address, which is transmitted during a vertical blanking interval, or other portion of a conventional video signal in such manner that displayed image quality is not affected. For example, the address signal can be transmitted during a portion of a video signal such as in the vertical interval, in sync or through changes in the luminance or chroma signals. Address extractor 42 is constructed to electronically store, e.g., via a register or memory device (not shown), the detected address for use in accessing the online services provider at the selection of the user. The address signal may be transmitted at very short intervals, e.g., once for each frame of a video program such that storing and refreshing of the extracted address signal occurs at very short intervals. Alternatively, the address signal may be transmitted at longer intervals, i.e., at discrete intervals in a program such that the duration in which an extracted address signal is stored is much longer.

In such cases in which video or audio program is encoded digitally, address extractor 42 may be constructed in any of several existing ways to detect an address signal which is received in conjunction with a digitally encoded video or audio electronic signal 12. The details of the construction of address extractor 42 are well known in the art and need not be described in further detail.

In another embodiment shown in FIG. 2, the uniform resource locators (URLs), or address signals, are encoded into the video in the same manner as described above. Again, the addresses of online content providers are preferably encoded onto eight fields of line 21 of the vertical blanking interval (VBI), but may also be sent independently of the video, or in more or less fields, or on different lines. In this embodiment, the address extractor 42 is located at the server site, as opposed to the subscriber location. When the address extractor 42 receives the electronic signal 12, it strips out the address codes on line 21 of the VBI and delivers these codes independently to an Internet server. The address code is then subsequently delivered over the network to the consumer's client device. Simultaneously, the video is broadcast using the electronic signal 12 to the access controller 10. Alternatively, the addresses may also be encoded into an audio portion of the electronic signal 12

In an alternative embodiment, the encoded address may be sent down independently of the electronic signal 12 on a data channel. In this embodiment, the address may be forwarded to the remote sites either prior to initiation or during the program. The addresses may have associated time stamps that indicate to the subscriber stations when, during the video program, to display the particular Web pages corresponding to the address. Alternatively, the consumer can select when to call the particular Web pages for display with the video program.

In yet another embodiment, addresses could be stored in a table, which may be forwarded to a client device either prior to initiation or during a program. Triggers may be sent to the client device during an audio or video program, which references one or more addresses in the table. These addresses are then used to establish a communications link between the client device and a provider of an electronic coupon associated with the table entry.

Address extractor 42 has an output connection to an indicator signal generator 46. The indicator signal generator 46 signals the consumer that more information relating to the program is available, such information being accessible through an electronic address when address extractor 42 has decoded the address from the electronic signal 12. Indicator signal generator 46 may cause, for example, a video image 20 (e.g., picture within picture, logo, or icon) to be displayed with the video program signal on reproducing system 22 to signal the consumer that an address of an online provider has been stored and that additional information is available. Instead of, or in addition to such visual display, indicator signal generator 46 may signal the consumer by activating a light 24 or other visual indicator located on an exterior panel of access controller 10 or of reproducing system 22. Alternatively, the indicator signal generator 46 may cause a sound to be produced on a speaker 26 of the reproducing system 22, or by a speaker 28 provided in access controller 10. Further, a tactile indicator signal may be produced by the indicator signal generator 46. Here again, the design of indicator signal generator 46 is well known in the art.

Access controller 10 is provided with a user interface 56 for receiving a consumer's command, which typically automatically initiates establishment of a direct digital communication link to an online information provider through an address received in the electronic signal 12 by address extractor 42. The user interface 56 also permits interactive communication between the consumer and the online information provider. It will be appreciated that many conventional interfaces are well suited for use as a user interface 56 because of their compatibility with conventional television and audio sound systems. Among suitable user interfaces are infrared, radio and audio frequency interfaces, which may decode single key or multiple key sequence inputs from a wired or wireless user remote control. Preferably, user interface 56 detects when a special purpose button on a remote user control has been pressed and provides a responsive signal, which automatically causes the stored address of the online provider to be retrieved and transmitted. The user interface 56 may also be constructed to detect when a special sequence of keys has been pressed on a conventional user control (e.g., a sequence such as “ENTER,” “ENTER,” “+VOLUME”) and to enable interactive communication with the online information provider. Alternatively, user interface 56 can be implemented by any appropriate mini- or microcomputer type user interface, such as a mouse, touchpad, touchscreen, trackball, joystick, pushbutton, keyboard, light pen, eraser head, or other such device. Further, the user interface 56 may be of a type compatible with a hand-held wireless device, such as a stylus or any of the above. Preferably, user interface 56 is constructed to provide and receive transmission of digital information signals through modem 54 to the online information provider, thereby enabling interactive consumer access with the online provider for conducting detailed information searches, conducting transactions, and sending or posting messages to the accessed provider.

Access controller 10 may be provided with a modem 54 for transmitting and receiving digital information signals through an information signal carrier line 32 to the public switching network 30 or devices connected thereto. Modem 54 demodulates incoming information signals and outputs them to processor 58, which extracts a video and/or an audio signal 38. Similarly, the modem also modulates outgoing information signals. The methods of modulating and demodulating signals are well known in the art. The access controller 10 may include a signal converter 62 for adjusting or converting an incompatible signal for display upon the conventional reproducing system 22, either in place of the incompatible signal, superimposed over the incompatible signal, or in picture-in-picture format, as controlled by the user.

Alternatively, processor 58 may provide the video signal on line 38 to a high resolution reproducing system 40, such as a computer monitor, PDA display, web phone, game console screen, or similar visual output presentation device. The indicator signal generator 46 may also incorporate a switch (not shown), which automatically switches off the primary output signal 36 whenever a signal appears at the output of signal converter 62. In this manner, information signals received from online information providers may be automatically displayed on the conventional reproducing system 22 in place of the ordinarily displayed video signal 36.

Processor 58 can also receive the input video or audio electronic program signal through a line 55 output from address extractor 42 (although direct connection of the electronic signal line 12 is possible). In this manner, processor 58 may be constructed to operate upon the video or audio signal in conjunction with information signals received from an online information provider to generate a “picture within picture” signal for display upon reproducing system 22.

Alternative embodiments may exist for use with the present invention. For example, the consumer may view an interactive program using a television set or other display monitor in conjunction with the display screen of the personal computer. In this embodiment, the relevant Web pages are shown on the client device while the video program is displayed on the television monitor. In this alternative embodiment, a cable set top box receives the television program from the multi-channel cable. The client device also receives the electronic signal from the multi-channel cable and extracts the address, embedded in the video signal or directly transmitted over the network 30. The client software extracts the address and retrieves the particular Web pages as described above. The Web pages are then synchronized with the particular video frames and presented to the consumer on the client device. It is understood that a hyperlink may exist on the Web site that will allow the consumer to automatically load the client software and call up the specific television channel referenced in the Web site. For example, suppose someone browsing the Internet may come upon a major television network's Web site. They may scroll to an interesting story, then click on a hyperlink to turn on the software, which in turn tunes the TV window to the network in order to enhance the information at the Web site.

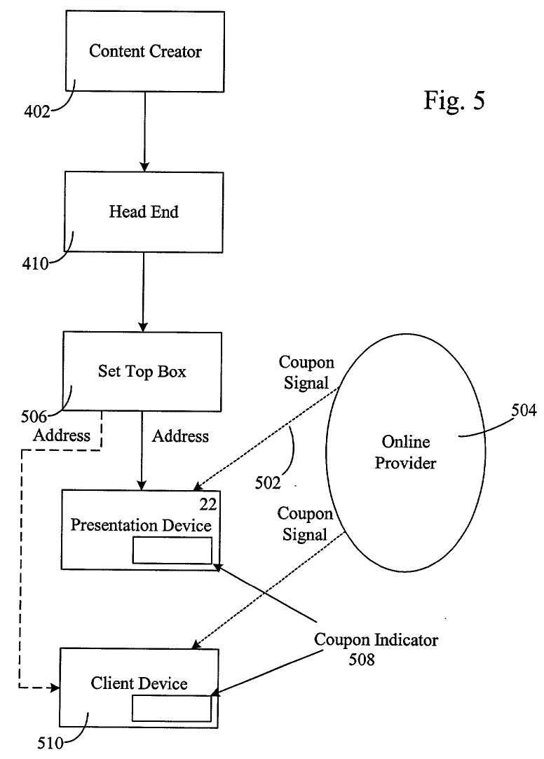

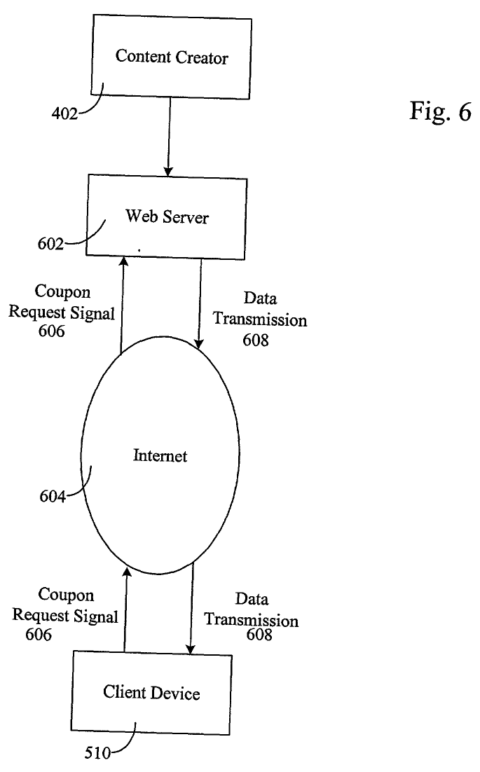

Alternately, a consumer may receive the electronic signal, Web pages, hyperlinks, or video program across a radio frequency link or other wireless transmission. For example, a consumer may employ a PDA or web tablet to hyperlink to Web sites synchronized with particular video frames, as described above. Throughout this application, it should be understood that references to electronic signals, programming, and so forth embrace wireless transmissions as well as more conventional land-line data transmissions. These concepts will be discussed in more detail with respect to FIGS. 5 and 6, below.

Furthermore, instead of receiving the video program via transmission, the video program can be addressed directly from the user site if the video program, with or without embedded addresses, or stored on a VHS tape, Betamax tape, DVD or other medium. In this embodiment, the consumer's PC and/or television are connected to a video playback device such as a videocassette recorder (VCR), DVD player or other appropriate device.

Returning to FIG. 1, the operation of the system will now be described. An electronic signal 12, such as a signal from a video or audio program from channel selector 16 or playback system 18, such as a prerecorded videotape, or an analog or digital video disc, and so forth, containing an embedded signal representing the electronic address of an online information provider in the blanking interval or other non-displayed portion of the electronic signal 12 is received by address extractor 42. From the electronic signal 12, address extractor 42 detects, decodes and stores a digital address of the online services provider, if any such address is embedded therein. If an address is successfully decoded and stored, address extractor 42 activates, through signal line 44, indicator signal generator 46. Indicator signal generator 46 then produces an indicator signal and overlays or encodes it onto a conventional program signal 36 to be displayed or transduced by conventional reproducing system 22. Alternatively, indicator signal generator 46 may produce a signal on line 50, which activates a special purpose indicator, e.g., illuminating a light 24 or producing a sound on a speaker 28 of access controller 10.

In another embodiment, the signal representing the electronic address of an online information provider is not embedded in the electronic signal 12 and is instead transmitted independently. In this embodiment, the address extractor 42 simply receives the online information signal and need not extract it.

If the consumer wants to access the online information provider, for example, to receive an electronic coupon, the consumer gives such command to access controller 10 by, for example, pushing a special button on his or her remote control device. The remote control device transmits a command signal to user interface 56, which receives the command signal. User interface 56 in turn, produces a signal, which is applied to address extractor 42 to retrieve the stored address of the online information provider. Under appropriate software or hardware control, the address is transmitted via modem 54 over network 30 to an online information provider 34a-34n.

Once access to the online information provider 34a-34n has been established, access controller 10 can automatically receive digital information signals through modem 54 from the online information provider. Received information signals are operated upon by processor 58 for displaying upon conventional reproducing system 22 or high-resolution reproducing system 40. Preferably, received signals, which are incapable of being directly displayed upon a conventional reproducing system 22, are converted by a signal converter 62 for display thereon.

Information signals received from an online information provider may be displayed as still or moving images in place of the ordinarily displayed video signal on the conventional reproducing system 22, or may be displayed as part of a “picture within picture” display in conjunction with the ordinarily displayed video signal on conventional reproducing system 22 or on the computer monitor 40 or other presentation device.

Alternatively, the information signals received from an online information provider are received directly by a personal computer connected to an associated computer monitor 40 or other presentation device. In this embodiment, a JAVA enabled browser is installed on the client device, which in this case may be a computer. Alternate embodiments may use other software in place of the JAVA enabled browser. The JAVA enabled browser (or similar software) allows the computer to retrieve the Web pages and is widely-used software, since it is platform independent, and thus enables efficient and flexible transfer of data over the Internet.

After access is established, commands received through user interface 56 are transmitted as information signals through modem 54 to the online information provider, thereby providing interactive consumer access with the online provider and enabling searching for detailed information, conducting transactions, sending or posting messages to the accessed provider and any other actions that can ordinarily be conducted through an online connection.

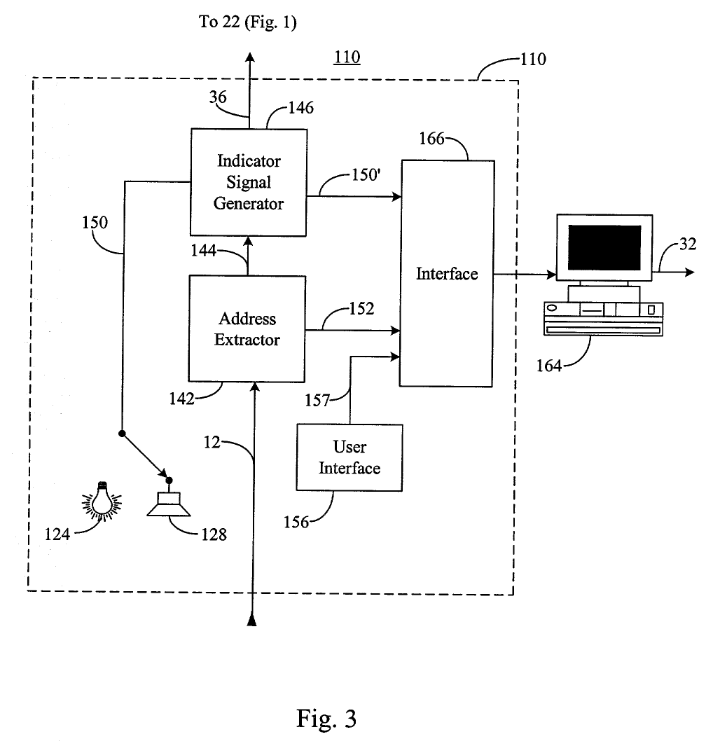

Another embodiment of the invention is illustrated in FIG. 3. FIG. 3 shows an embodiment, which operates in conjunction with an available computer 164. In this embodiment, access controller 110 does not require an internal processor or modem because such functions are provided by a computer 164 attached thereto. In addition, computer 164 also provides video and audio reproducing components which function as a high resolution reproducing system 40. Address extractor 142, indicator signal generator 146, and user interface 156 are connected through an output interface 166 to the computer 164 for providing decoded address output, indicator signals, and user commands, respectively. In other respects, access controller 110 is connected to receive an electronic signal 12, provide a conventional program signal 122, and provide a signal 150 to indicator 124 or indicator 128, in like manner as the self-contained access controller 10 described with respect to FIG. 2. It will be appreciated that this computer enabled embodiment provides the same function and operates in essentially the same manner as the self-contained embodiment described with respect to FIGS. 1 and 2 and accordingly need not be described in further detail.

In still another embodiment of the invention, with reference to FIGS. 1-3, a connection to network 30 is maintained continuously by access controller 10 through modem 54 or the modem provided in computer 164. This embodiment will be described with reference to the access controller 10 shown in FIG. 2, although a skilled person in the art will readily understand that structural modifications to the access controller shown in FIG. 3 will enable that controller to operate in a similar manner. In this embodiment, address extractor 42 detects and decodes an online information provider's address embedded in the video or audio program signal, but does not store the address.

As described in the foregoing embodiments of the invention, address extractor 42 provides a signal to indicator signal generator 46 when it successfully detects an online information provider address in the electronic signal. Address extractor 42 detects and decodes the embedded address and passes it to modem 54.

As also described in the foregoing embodiments of the invention, the address extractor 42 could simply receive the online information provider address if such signal is not embedded in the electronic signal containing the video programming. In this embodiment, the address would be passed directly to the modem 54.

Modem 54, in turn, only uses the extracted address if it has first received a command to initiate access to the online information provider. It will be appreciated that this embodiment of the invention can be used with a video or an audio program signal wherein the online information provider address is frequently or continuously transmitted. Modem 54 is provided with hardware and/or software to automatically establish, upon receiving a command to initiate online access, a direct digital communication link with the online information provider associated with the next received online information provider address.

As an example of the operation of this non-address storing embodiment of the invention, a video or an audio program signal having a frequently transmitted embedded signal containing an online information provider address is received through line 12 by address extractor 42. Address extractor 42 detects and decodes the online information provider address, but does not store it before passing it to modem 54. Modem 54 does nothing with the online information provider address unless a command to initiate access has first been received from user interface 56. If such command has been received, modem 54 transmits a signal over network 30 using the next received address to establish a digital communication link with the online information provider. The function and operation of the non-address storing embodiment is otherwise the same as in the other described embodiments of the invention and need not be described in any further detail.

In yet another embodiment of the invention, automated direct consumer access to online information providers is achieved without incorporating an indicator signal generator 46, 146 (FIG. 3) into the access controller 10. In this embodiment, the video or audio program as produced incorporates a visual or auditory indicator, such as a logo or message, which is automatically displayed or sounded by conventional reproducing system 22 and/or high resolution reproducing system 40 during portions of the program when an online information provider address is present in the underlying electronic program signal. Through the visual or auditory indicator, the consumer is made aware of the availability of the online information provider address. Therefore, in this embodiment of the invention, address extractor 42 may be constructed and used in a manner so as to detect and decode an embedded online information provider address only after receiving a command to initiate access to the online information provider.

The skilled person in the art will appreciate that this embodiment of the invention operates in other respects as in the other embodiments of the invention described in the foregoing and need not be described in further detail.

In yet another embodiment, automated direct consumer access to online information providers is achieved without any consumer interaction. The URLs or online addresses are instead “pushed” to each consumer, eliminating the need for the indicator signal generator 46 and the user interface 156. The ability to push online content to consumers is described in detail in U.S. Pat. Nos. 5,774,664, 6,018,768, and 5,788,181, all of which have been incorporated by reference. Pushing data, and the related concept of “pulling” data, will be discussed in more detail below.

Turning briefly to FIG. 5, the online provider address may be transmitted either to the presentation device, or to a client device. Where the address is transmitted to a client device, many forms of data transmission may be used. For example, the client device might receive the address via wireless radio or infrared frequencies, across a direct physical link, by mating with a docking station, and so forth. Other manners of transmitting the online provider address to a client device will become apparent to those skilled in the art upon reading this description.

Electronic Coupons

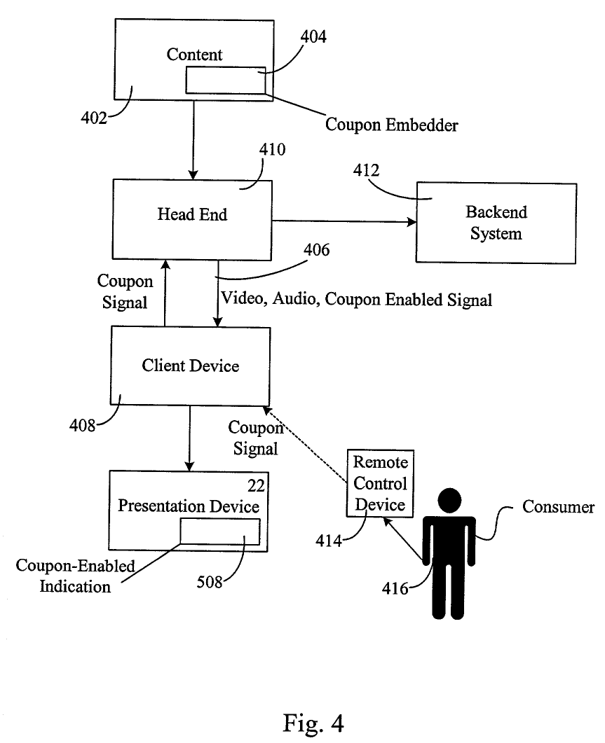

The system of the present invention combines the extensive capabilities of video and online providers with the capability of creating easy-to-use and customized electronic coupons. Online providers may be remotely located across an intranet, the Internet, or another network. Referring to FIG. 4, an embodiment of the invention is shown as a television-based system for receiving a video program along with an embedded coupon-enabled signal—which, when actuated by the consumer using, for example, a coupon key on a remote control creates an electronic coupon that provides the viewer with a discount at the appropriate retail or service provider location.

The video programming may be created at a centralized location, such as the content creator 402 shown in FIG. 4, for distribution to subscribers. Program creation is accomplished according to any conventional means known in the art. In one embodiment, after a video program is created, coupon-enabled signals are embedded into eight fields of line 21 of the vertical blank interval of the video programming by the coupon embedder 404, as shown in FIG. 4. Line 21 is typically the line associated with closed captioning, among other things. The particular information in line 21 is not part of the visual part of the program, and thus is not perceptible to the human eye, thereby making it ideal to send data information to the consumers. However, the coupon-enabled signal could also be embedded in other fields of the VBI, in the horizontal portion of the video, as part of the audio channel, in any subcarrier of the video, or, if digital, in one of the data fields. Essentially, the coupon-enabled signal may be embedded in any portion of the programming signal not intended for display on the presentation device.

The coupon-enabled signal can be created and optionally embedded at a variety of locations, such as the original content creator (e.g., the network) or content distributor (e.g., the local cable provider). The coupon-enabled signal can be used in cooperation with the combined online information and video programming described previously in relation to the discussion of FIGS. 1-3. The coupon-enabled signal could be, for example, embedded in the same programming in which the online provider addresses are embedded (as described in the discussion of FIGS. 1-3). Alternatively, the coupon-enabled signal, the online provider address, or neither signal may be embedded in the video programming itself.

Although FIG. 4 shows the video with the coupon-enabled signal over the same transmission line 406, the coupon-enabled signals may alternatively be transmitted independently of the video program on a data channel 502, as shown in FIG. 5. In this embodiment, the coupon-enabled signals can be forwarded to an online provider either prior to initiation or during the program. The coupon-enabled signals may also have associated time stamps that indicate to the subscriber stations when, during the video program, to display the particular coupon-enabled indications associated with the coupon-enabled signals. The coupon-enabled signal is typically associated with an advertisement, but could be associated with any programming, including movies, sports, news, entertainment, or educational programming.

In an alternative embodiment, the coupon-enabled signal is not associated with any particular programming. Instead, a coupon-enabled signal could be sent to a consumer independent of what program they were watching, or even independent of any programming at all. For example, a coupon for a discounted pay-per-view movie could be transmitted to all consumers, regardless of their current viewing selection.

Once the video programming is created, it can be transmitted to consumers over any transmission means, including broadcast television, cable, satellite, the Internet, an intranet, a local area network (LAN), and so forth, and may reside on video servers. The particular video programming can be delivered in analog, digital or digitally compressed formats (e.g., MPEG2, MPEG4, etc.). Furthermore, the video programming, with or without embedded URLs, can be encoded on a VHS or Betamax tape, DVD or other medium.

With reference to FIGS. 4 and 5, a coupon-enabled signal is sent to the set top box embedded in the video signal with which it is associated. Again, the coupon-enabled signal may be transmitted from the content creator 402, as in FIG. 4, or may originate at an online provider 504 as shown in FIG. 5. The set top box performs many of the same functions as the access controller 10 (described in relation to FIGS. 1-3). The set top box 506 transmits the video signal to an associated presentation device 22 for display to a consumer. The associated presentation device 22 is often a television set or other display monitor, but can be a digital television, television-enabled personal computer, mobile web phone, PDA, or other portable presentation device.

The coupon-enabled signal sent to the set top box may contain information indicating whether the video programming is coupon-enabled or not. If the consumer indicates that he or she desires an electronic coupon, the set top box registers that fact in association with the program, advertisement, or time tag existing simultaneously with the request. Preferably, requests for electronic coupons are stored in the set top box 506 until being sent to the head-end 410 at regular intervals, upon request by the head-end 410, or upon request by the consumer. The electronic coupons may also be stored at a backend system 412 and stored until requested by a consumer 416, for example, via a remote control device 414. Alternatively, the coupon signals could be sent immediately upon receipt by the set top box 506. In an alternative embodiment, the set top box 506 does not transmit the information to the head-end 410, and instead embeds the information on a portable coupon device such as a smart card, as described in detail below.

The set top box 506 may also transmit the coupon-enabled signal to an associated presentation device 22. When the coupon-enabled signal indicates that an electronic coupon is available, a coupon indicator 508 is also displayed on the presentation device 22 so that the consumer knows that an electronic coupon is available. The coupon indicator 508 may be displayed on the video screen, such as a small icon shown in one corner of the screen. Alternatively, the coupon indicator 508 may take other forms, such as a temporary indication on the display screen near the beginning of the coupon-enabled timeframe, variations in color or appearance, or portions of the display screen, text or graphic indications, or even an audio cue. As an example, an advertisement for BrandX orange juice might indicate by text on the screen that a one-dollar coupon for use at a particular store is available.

In an alternative embodiment shown in FIG. 5, the coupon indicator 508 may be displayed on a client device 510 such as a PDA, telephone, or game console, rather than on a presentation device 22. This permits the coupon indicator to move about with the client device 510 rather than tying it to a relatively fixed location, such as the presentation device 22. In this manner, a user may receive a coupon indication even if he cannot view the presentation device 22. The coupon-enabled signal is typically transmitted across a wireless link, such as a radio frequency or infrared broadcast, between the client device 510 and the set-top box 506. Although FIG. 5 displays a set-top box 506 transmitting the address to the client device 510, it should be understood that any transmission means capable of relaying a signal to the client device 510 may be used. For example, a cellular tower may be used to transmit the address to a client device 510 such as a web phone or PDA, or a base station might relay the address to a web tablet. Accordingly, the set top box 506 shown in FIG. 5 should be regarded as illustrative only.

In yet another alternative embodiment, no coupon-enabled indicator is used. Rather, a viewer may request an electronic coupon during programming, either based on a programming cue (e.g., the actor in a commercial mentioning the availability of a coupon) or without knowing for certain that an electronic coupon is available.

The coupon-enabled indicator is similar in function to the special purpose indicator described in relation to FIGS. 1-3. If both the coupon-enabled indicator and the special purpose indicator are used with the same embodiment, two different indicators may be used. Alternatively, a single indicator could be used for both. For example, a light could shine with a blue color when online content is available, a yellow color when an electronic coupon is available, and green if both were available.

Video Programming and the Internet

As shown in FIGS. 6-8, the present invention may take advantage of the combination of traditional television programming and the massive content of online providers. As previously described in relation to FIGS. 1-3, the embodiment may include an access controller 10 (or set top box) connected to a video signal source 14 (such as the content creator of FIG. 6) and a network 30 connected to an online information provider via a Web server 602. The electronic signal 12 between the access controller 10 and the video signal source 14 contains the video or audio program as well as embedded signal representing the electronic address of an online information provider.

With particular reference to FIG. 6, an example of an embodiment accessing the resources of the Internet 604 is shown. A client device 510 may initiate a coupon request signal 606, passed through the Internet 604 to a Web server 602 or site associated with a content creator 402. In response, the Web server 602 initiates a data transmission 608 to the client device 510, again routed through the Internet 604. When received, the client device 510 can interpret and store the data transmission 608 as an electronic coupon, as previously described. The data transmission 608 to the client device 510 may be either a wireless or line-bound transmission, including radio frequency, infrared, audio frequencies, and so forth, depending on the reception capabilities of the client device 510. Additionally, although the term “Internet” is used, any network or combination of networks as previously described may carry the data transmission from the Web server 602 to the client device 510. Finally, while FIG. 6 shows the Web server 602 receiving signals from the content creator 402, it may easily receive data from an online provider as well.

The signal representing the electronic address of an online information provider may also be transmitted independently of any programming signal. When a consumer desires to access online information related to the current programming, the consumer may send a command to the access controller 10, the access controller 10 sends the address to the online information provider, and the online information provider converts the appropriate online information into a digital information signal and transmits it to the access controller. Preferably, the video or audio program is displayed to the consumer on a television or other presentation device 22, and the online information can be displayed to the consumer on the same device (a “one-box” embodiment) or on a different presentation device, such as a computer monitor 510 (a “two-box” embodiment).

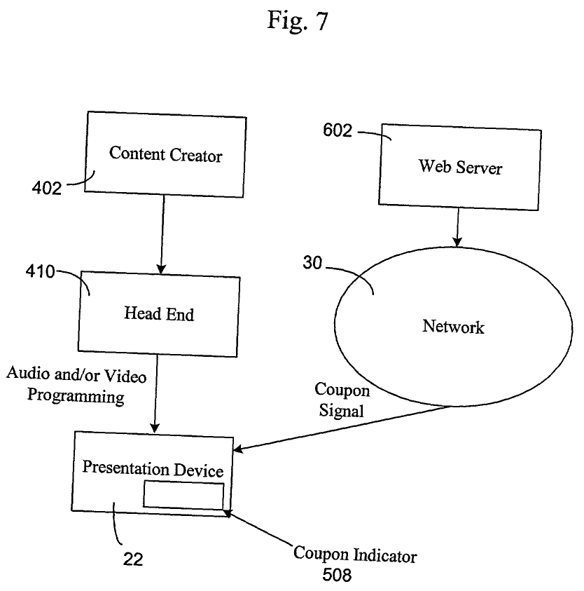

The electronic coupon system works with either a one-box embodiment or a two-box embodiment. In the one-box embodiment shown in FIG. 7, the coupon-enabled signal can be transmitted to the same presentation device 22 that is displaying the video or audio programming and the online information. In this embodiment, the coupon-enabled indicator could be a different indicator than the indicator signal or the two signals could be combined.

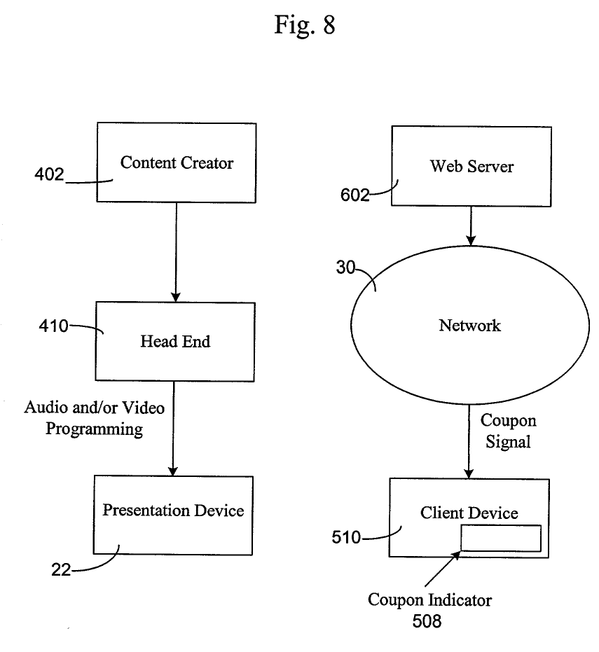

FIG. 8 shows a two-box embodiment of the present invention. In the two-box embodiment, the audio or video programming usually is sent to a presentation device 22 and the online information is sent to a client device 510. The coupon-enabled indicator 508 can be located on either the presentation device 510 or the client device 22. The coupon-enabled signal may be transmitted with the video signal to the set top box (not shown). Alternatively, the coupon-enabled signal could be sent directly to the presentation device 22 with the online information. For example, the coupon could be associated with online information content instead of video programming.

“Pushing” and “Pulling” a Coupon

In one embodiment, the consumer of coupon-enabled programming may indicate that he or she wishes to take advantage of an electronic coupon (known as “pulling” the electronic coupon). The consumer may indicate a desire to receive an electronic coupon by actuating a coupon key on a remote control device for the client device. The coupon key may be a separate, clearly marked key available on the remote control device. Alternatively, a pre-existing key on the remote control could also function as a coupon key. Other possibilities for a consumer requesting an electronic coupon include voice-actuated requests, a button or actuation device mounted on the client device, clicking with a mouse or other user input device on a hypertext link or icon, a separate coupon remote control, a PDA, or any form of client device indication. Although pulling a coupon often results in an indication that the electronic coupon has been received, no coupon-enabled indicator is necessary. Alternate embodiments of the present invention may simply deliver the coupon to a client device without including any indication thereof.

In yet another embodiment, the viewer of coupon-enabled programming does not take any action and instead automatically receives an electronic coupon (referred to as “pushing” the electronic coupon). Accordingly, no coupon-enabled indicator is necessary. In this push embodiment, the electronic coupon provider decides the criteria necessary for a consumer to receive an electronic coupon. For example, every consumer receiving a program or advertisement might receive a coupon for the associated product.

Further, the electronic coupon received may be customized for that consumer. During a Ford commercial, for example, each consumer could automatically receive an electronic coupon, but the coupon could vary depending on the consumer's user profile. For example, the coupon may be valid only at local dealerships, or a hiking enthusiast may receive an SUV coupon while an environmentalist might receive an economy car coupon.

When the consumer makes a request for an electronic coupon, the request is transmitted to the client device. After the client device receives the coupon signal, a number of possibilities for processing the electronic coupon exist, as will be described below.

Back End System Embodiments

In one embodiment, the client device transmits a message to the head-end indicating that the consumer would like to take advantage of the electronic coupon offer. The head-end then sends an identification of the consumer and information about the electronic coupon (e.g., the time of request, the associated programming, and/or the amount of the coupon) to a back-end system, which could be a server associated with an individual retailer or company, or alternatively could be an administrator of electronic coupons for a number of individual retailers or companies. Preferably, the electronic coupon information is stored in a database for later access. When the consumer purchases a product at the retailer or company, the value of the electronic coupon could be automatically deducted from the purchase price. The electronic coupon may be purged from the database after use. Further, it is to be appreciated that the consumer identifier may be any type and/or level of identification, including a random number assignment or a precise identification of the consumer by name, address, and social security number.

In yet another embodiment, the consumer's request for an electronic coupon is not transmitted to a client device and is instead transmitted directly to a back-end service. For example, in a two-box embodiment, the consumer could click a button on a client device and thereby indicate that the consumer desires an electronic coupon. Using an Internet connection, for example, the consumer's request could be sent directly to any online content provider sales server with an Internet, wireless, or other network connection. Alternately, the request could be stored on a client device for later transmission and/or retrieval.

Portable Coupon Device Embodiments

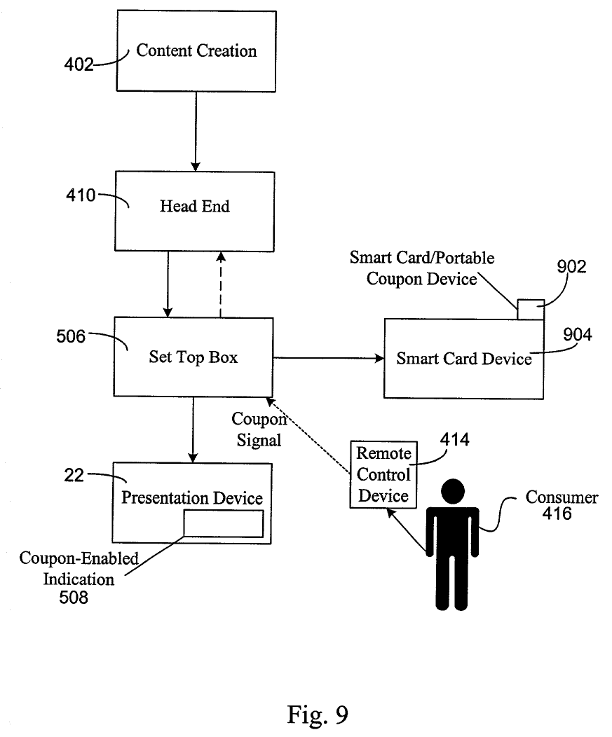

Turning now to FIG. 9, one embodiment allows the consumer to invest a smart card 902 into a smart card device 904 in communication with the set top box 506. The set top box 506 may then imprint the smart card 902 with the electronic coupon information when the coupon key is pressed and the information is processed. The consumer can then remove the smart card 902 from the set top box 506 and bring the card 902 with them to the retailer or company, and redeem the coupon by presenting the smart card to the cashier or using a reader at the retailer. The electronic coupon value can then be deducted from the bill if the proper product was purchased, and the electronic coupon may be purged from the smart card 902.

While a smart card 902 is used as a portable coupon device in the currently discussed embodiment, other portable coupon devices are possible. For example, magnetic cards, wireless smart cards, credit cards, cellular phones, personal digital assistants, or mobile devices could be used. In addition, when a wireless smart card is used, a device at the retailer could automatically detect the presence of the wireless smart card and deduct the value of the electronic coupon from the purchase price, requiring no knowledge of the electronic coupon by the viewer/beneficiary or even the cashier working with the viewer.

Expiration Dates

As with traditional coupons, an electronic coupon may include an expiration date after which the electronic coupon is no longer valid. In an embodiment using a back-end system, an expired electronic coupon is typically purged from the database. In embodiments using portable coupon devices, the electronic coupon can be automatically deleted or it can be simply denied when redemption of the coupon is attempted.

Customization and User-Profiles

Moreover, the use of electronic coupons allows retailers and the head-end to track usage of coupons and purchase of products. This information can be cross-referenced with other data, such as demographics, purchasing patterns, or any other information. By combining these sources of information, valuable new information about purchasing patterns and use of coupons can be garnered. In addition, electronic coupons can be customized for an individual consumer. Customization can include locations for redemptions (only works at a certain store, for example), value of the electronic coupon (based on salary, demographics, prior coupon usage), and type of product that an electronic coupon can be used for (a Ford SUV instead of a Ford Mustang for outdoor enthusiasts). Preferably, customization information is stored in a user profile.

In an embodiment, user profile information is stored in a “donut” of dynamic, hierarchical, shared user profile information. A donut may specify user characteristics, viewing preferences, hobbies, and/or spending habits. A donut may also specify any other user profile information and is not limited to the preceding list. The donut contains a user profile or acts as a key to a data repository containing such profiles, and it may be stored in a file-type structure on a computer-readable medium such as a memory. The donut is accessed by browser programs, associated web server programs, and other applications for use in routing content to the client device associated with the donut. The term “donut” is used only as a label and refers to information residing on a server and accessible by a user for use in pushing or assigning particular content to the consumer. After creating or updating a donut for the consumer, the server selects content for transmission to the consumer based upon the user-profile information stored in the consumer's donut.

The donut file for a particular consumer is typically stored only on the server at a centralized remote location, but could be stored locally on the consumer's machine or on both the server and the consumer's machine. The donut thus implements a dynamic store of shared profile data that is exchanged between the consumer's machine (client) and server, with the flexibility to collect and process that data in three ways: client-side evaluation, http-based server-side evaluation, and network-based server-side evaluation. Because donut files are stored on a server, a consumer may log onto a network from any machine and still access the consumer's donut file and receive content based upon the donut file.

Donuts can be dynamically modified and updated to further fine-tune the processing of selecting particular content to push to the consumer based upon the consumer's donut. In the coupon context, the answers to survey questions may be used to provide a different type, location, method of redeeming, or geographical limitation for an electronic coupon. Similarly, the demographic information about a consumer contained in the donut can be used to provide different electronic coupons to the consumer. For example, a resident of a city may only receive coupons for retailers located within 50 miles. The donut may also include content related to a program being viewed by the consumer. For example, if the consumer views a sports program, a coupon may be based on products, such as team jerseys, related to the teams being viewed on the sports program or a consumer's favorite team as based on the consumer's identified preferences or interests as saved in the consumer's donut.

The consumer's activity may also be monitored in order to dynamically update the consumer's donut. The consumer's activity may involve any type of information relating to the consumer's interaction with the network or program content provided to the consumer. For example, the server may detect the following: the rate at which the consumer selects or “clicks on” URLs or electronic coupons; which URLs or electronic coupons the consumer selects; the amount of elapsed time the consumer has remained logged onto the network; the extent to which the consumer participates in chat room discussions; and any other such information. In order to decide whether to update the donut, particular types of activity or thresholds for activity may be compared with the consumer's monitored activity, providing for an update when the consumer's activity matches the particular types of activity or exceeds the thresholds. The may also be updated based upon survey questions.

Internet-based Electronic Coupons

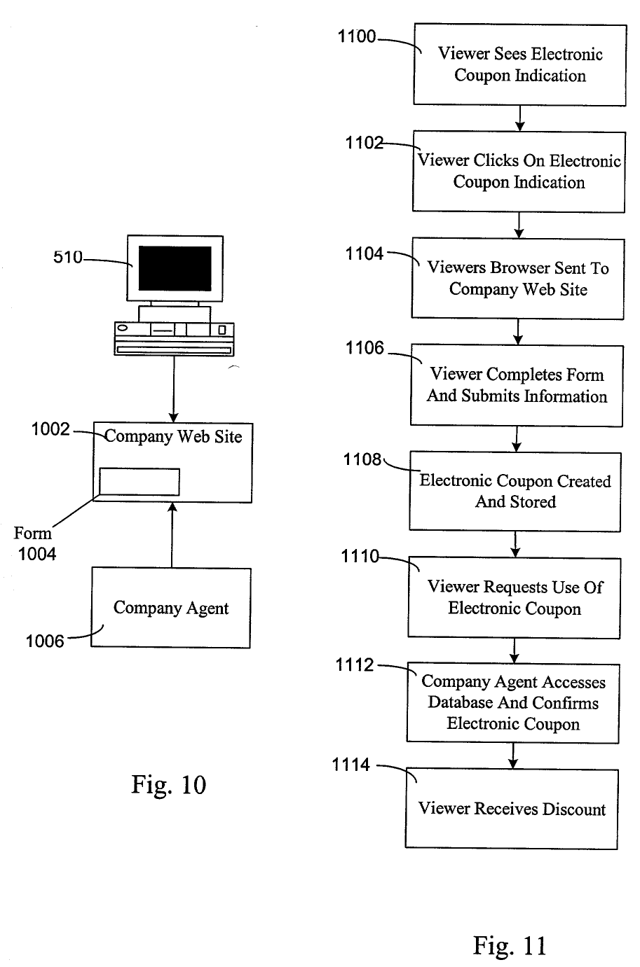

In another embodiment of the present invention, an Internet-enabled client device is used, as shown in FIG. 10 and described in FIG. 11. This embodiment takes advantage of the power of the World Wide Web to provide electronic coupons to consumers. Preferably, an indication is given to the consumer of a website 1002 that an electronic coupon is available (Operation 1100). This indication could be located in a banner advertisement, a separate pop-up window, or in a hypertext-link to another website which is presented on a client's device 510. For example, a banner advertisement could indicate that if the consumer fills out a form, an electronic coupon will be available to give the consumer $50 off the purchase price of a set of four tires at a local tire retailer. The retailer is known as the electronic coupon recipient.

The consumer may click on the banner advertisement (Operation 1102) and be sent to the company's website 1002 (Operation 1104), where he/she may fill out a form 1004 (Operation 1106). Forms are often used because they allow information about the consumer to be gathered so that the electronic coupon is given to the correct person. Additionally, other data could be gathered from the consumer, just as in any sort of survey. The data could include demographic information and buying preferences, as well as information on other products owned by the consumer.

After the form 1004 is completed, the electronic coupon information may be created saved in storage associated with the company website 2003 (Operation 1108). Access to the company website 1002, and its storage, is often secure and only available to authorized personnel, but may be generally accessible. For example, when the beneficiary of an electronic tire coupon goes to the retailer to purchase new tires, a representative or agent 1006 of the company may access the company website 1002 to determine whether the consumer has a valid electronic coupon. If the consumer of the store is the same as the consumer who received the electronic coupon, the consumer receives the discount on his or her purchase.

Alternatively, when the consumer fills out the form on the company web page, a message can be sent to the consumer's client device that an electronic coupon of a certain amount is authorized. Preferably, a smart card imprinter is operably connected to the client device. When the valid electronic coupon is received from the company website, the electronic coupon is imprinted onto the smart card. As described above, magnetic cards, wireless smart cards, credit cards, cellular phones, personal digital assistants, or mobile devices could be used in place of the smart card consistent with the present invention.

When the smart card owner goes to the retailer offering the coupon (Operation 1110), the retailer can access the smart card (Operation 1112), read the valid electronic coupon, and provide the smart card owner with the appropriate discount (Operation 1114). As described above, the electronic coupon is typically deleted from the smart card after it is used, although alternate embodiments may continue to store the electronic coupon for such purposes as coupon preference tracking, determining the length of time between receipt and use of the coupon, and so on.

In another embodiment of the system, the consumer need not fill out a form and instead only has to request an electronic coupon. Typically, some method of authenticating a consumer is available so that the proper recipient of an electronic coupon is achieved. However, if a portable coupon device is used, the electronic coupon can be embedded onto the portable coupon device when the coupon is requested. For example, a consumer could request an electronic coupon from a Ford banner advertisement on a Web page and an electronic coupon could be immediately embedded onto an associated portable coupon device.

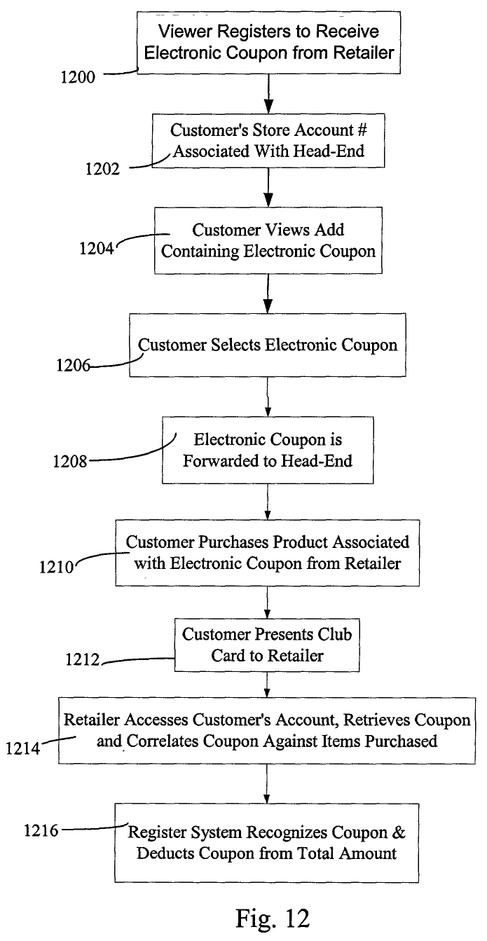

In another embodiment, as shown in FIG. 12, the electronic coupon is automatically, or upon consumer direction, associated with a retailer's club card. In this embodiment, the consumer registers with the retailer or others to receive an electronic coupon from the retailer (Operation 1200). It is to be appreciated that the retailer may be a local retailer, a regional retailer or even a national chain. Upon registration, the consumer's club card is then associated with the cable head-end system or other system providing the electronic coupon (Operation 1202). This operation may involve creating pointers, tying databases together, or other functions in order to provide notification and/or information to the retailer's club card system about an electronic coupon.

When the consumer views (or hears) an advertisement containing an electronic coupon indication (Operation 1204), the consumer suitably selects the coupon (when a “pull” operation exists) or is automatically provided with the coupon (when a “push” operation exists) (Operation 1206). The electronic coupon is then forwarded to the head-end or backend system processing the coupon and sufficient information is added to the retailer's database in order for the retailer to eventually process the electronic coupon (Operation 1208).

When the consumer proceeds to the retailers and buys a product or service associated with a stored electronic coupon (Operation 1210), and presents their club card (Operation 1212) the retailer's system accesses the electronic coupon (which may be stored in the retailer's database at the head-end, backend or otherwise) and correlates the coupon against the items purchased (Operation 1214). When a correlation exists, the retailer's system the automatically deducts the coupon from the purchase price and the transaction is completed (Operation 1216). As such, in this embodiment, an electronic coupon is associated with a specific retailer (or chain of stores) such that a consumer need only utilize a club card in order to gain the benefit of an electronic coupon.

While the invention has been particularly described and illustrated with reference to multiple embodiments thereof, it will be understood by those skilled in the art that changes in the above description or illustration may be made with respect to form or detail without departing from the spirit and scope of the invention. It is intended that all matter contained in the above description or shown in the accompanying drawings shall be interpreted as illustrative only and not limiting.

1. A method for providing an electronic paperless coupon in conjunction with a programming signal to at least one consumer, comprising:
generating a programming signal;
generating an electronic coupon signal;
transmitting the programming signal and the electronic coupon signal to at least one consumer;
wherein the electronic coupon signal relates to content provided in the programming signal.

2. The method of claim 1, further comprising embedding the electronic coupon signal into the programming signal.

3. The method of claim 2, wherein the electronic coupon signal is embedded into the programming signal.

4. The method of claim 3, wherein the electronic programming signal is embedded into the vertical blanking interval of a video portion of the programming signal.

5. The method of claim 1, wherein the electronic coupon signal further comprises an address identifying an online information provider providing an electronic coupon, whereupon establishing a communications link between a client device and the online information provider the electronic coupon can be obtained.

6. The method of claim 1, wherein the programming signal and the electronic coupon signal are transmitted by a head-end system.

7. The method of claim 6, wherein the programming signal and the electronic coupon signal are communicated separately.

8. The method of claim 6, wherein the programming signal is communicated over a first data channel and the electronic coupon signal is communicated over a second data channel.

9. The method of claim 1, wherein the electronic programming signal includes a time stamp indicating when relative to the programming signal to present the electronic coupon signal to the at least one consumer.

10. The method of claim 1, wherein the electronic coupon signal is transmitted to the at least one consumer independent of the programming signal.

11. The method of claim 1, wherein at least one of the programming signal and the electronic coupon signal is communicated to the consumer over at least one of broadcast television, cable, satellite, the Internet, an intranet, a local area network, a wide area network, a wired network and a wireless network.

12. The method of claim 1, wherein at least one of the electronic coupon signal and the programming signal is provided in an analog, a digital or a digitally compressed format.

13. The method of claim 1, wherein the programming signal is communicated over a first communications link and the electronic coupon signal is communicated over a second communications link.

14. The method of claim 12, wherein the electronic coupon signal is communicated over a packet switched network.

15. A method of communicating an electronic coupon signal to at least one consumer, wherein the electronic coupon signal relates to a programming signal transmitted to the at least one consumer, wherein the programming signal includes an address identifying an online information provider providing online content related to the programming signal, comprising:
obtaining an electronic coupon signal; and
communicating the electronic coupon signal to the at least one consumer.

16. The method of claim 15, wherein the electronic coupon signal is communicated in conjunction with the programming signal.

17. The method of claim 15, wherein the electronic coupon signal is communicated independent of the programming signal.

18. The method of claim 15, wherein the electronic coupon signal relates to the content of at least one of the programming signal and the online content.

19. The method of claim 15, wherein the electronic coupon signal is communicated to the at least one consumer over at least one of a packet switched network, the Internet and an intranet and the programming signal is communicated to the at least one consumer via at least one of a cable system, broadcast television, broadcast radio, and a satellite system.

20. A method of applying an electronic coupon to a transaction, comprising:
determining whether at least one electronic coupon is available to apply to a transaction for at least one good or service; and
when at least one coupon is available to apply to the transaction, applying the at least one coupon to the transaction;
wherein the electronic coupon relates to a programming signal communicated to a consumer.

21. The method of claim 20, wherein the determination of whether at least one electronic coupon is available to apply to a transaction further comprises:
obtaining access to an electronic coupon;
determining whether the electronic coupon relates to a good or service set forth in the transaction; and
when a relationship exists between the electronic coupon and the good or service, designating the electronic coupon as available to the transaction.

22. The method of claim 21, wherein the electronic coupon is obtained from a portable coupon device.

23. The method of claim 22, wherein the portable coupon device further comprises a smart card presented by the consumer.

24. The method of claim 22, wherein the portable coupon device further comprises a consumer's club card.

25. The method of claim 21, wherein access to the electronic coupon is obtained from at least one of a backend system, a head-end system and a database.

26. The method of claim 25, wherein the backend system further comprises a server associated with at least one retailer and an administrator of electronic coupons for a plurality of retailers.

27. The method of claim 20, wherein the at least one electronic coupon is communicated to a consumer in an electronic coupon signal provided in conjunction with a programming signal into which at least one address has been inserted which identifies an online information provider providing content related to the programming signal.

28. The method of claim 27, wherein the electronic coupon signal is presented to the consumer on a client device and the programming signal is presented to the consumer on a presentation device.

29. The method of claim 28, wherein the electronic signal and the programming signal are presented to the consumer at the same time.

30. The method of claim 20, further comprising:
receiving an indication from a consumer that the consumer desires to utilize an electronic coupon presented in relation to a programming signal;
saving the electronic coupon in a database.

31. The method of claim 30, wherein the indication that the consumer desires to utilize an electronic coupon is provided by a communications signal transmitted by a remote control device accessed by the consumer.

32. The method of claim 31, wherein the communications signal is transmitted by the remote control device upon the consumer depressing a coupon select button.

33. An article of manufacture comprising:
a computer usable medium having computer readable program code, the computer readable program code including instructions for processing an electronic coupon related to a programming signal by:
receiving a communication from a portable coupon device;
determining, based upon the communication, whether an electronic coupon related to a programming signal is available;
comparing each transactional item entered into a merchant transaction processing system with each available electronic coupon, wherein one result of the comparison indicates that an electronic coupon relates to a transaction and designates the electronic coupon as a redeemable electronic coupon;
applying each redeemable electronic coupon to the transaction;
whereupon applying a redeemable electronic coupon an amount owed for the transaction is reduced by an amount specified by the redeemable electronic coupon.

34. The article of manufacture of claim 33, wherein the article of manufacture comprises at least one of a compact disc, DVD, a memory stick, a magnetic disc, magnetic tape, optical disc, memory card, a magnetically readable device, an optically readable device, and a holographically readable device.

35. The article of manufacture of claim 33, wherein the communication from the portable coupon device is received by swiping a magnetically readable card through a card reader.

36. The article of manufacture of claim 33, wherein the communication from the portable coupon device is received by scanning an optically readable device with an optical scanner.

37. The article of manufacture of claim 33, wherein the portable coupon device further comprises a consumer's club card.

38. The article of manufacture of claim 33, wherein the portable coupon device further comprises a smart card.

39. The article of manufacture of claim 33, wherein the portable coupon device further comprises at least one of a magnetic card, optical card, wireless smart card, credit card, wireless telephone, personal digital assistant, and a mobile device.

40. The article of manufacture of claim 33, wherein the electronic coupon is stored at a cable head-end and the operation of determining whether an electronic coupon is related to a programming signal is available further comprises:
establishing a communications link with a database;
based upon an identification of a consumer, determining whether any electronic coupons are available for the consumer to redeem; and
when an electronic coupon is available, obtaining an identification of each available electronic coupon.

41. The article of manufacture of claim 40, wherein the database is provided at at least one of a cable head-end, a backend, an electronic coupon clearance system, and a merchant database.

42. The article of manufacture of claim 40, wherein the identification of the consumer is obtained from the portable coupon device.

43. The article of manufacture of claim 33, wherein the electronic coupon is provided to a consumer in conjunction with a programming signal.

44. The article of manufacture of claim 43, wherein the programming signal includes at least one address identifying a provider of online content which relates to the programming signal.

45. An article of manufacture comprising:
a computer usable medium having computer readable program code, the computer readable program code including instructions for processing an electronic coupon related to a programming signal, by:
determining, with respect to a transaction, whether an electronic coupon related to a programming signal is available;
comparing each transactional item entered into a merchant transaction processing system with each available electronic coupon, wherein one result of the comparison indicates that an electronic coupon relates to a transaction and designates the electronic coupon as a redeemable electronic coupon;
applying each redeemable electronic coupon to the transaction;
whereupon applying a redeemable electronic coupon an amount owed for the transaction is reduced by an amount specified by the redeemable electronic coupon.

46. The article of manufacture of claim 45, wherein the operation of determining whether an electronic coupon is available occurs upon request from a consumer to the transaction.

47. The article of manufacture of claim 45, wherein the operation of determining whether an electronic coupon is available occurs automatically upon an identification of a consumer to the transaction.

48. The article of manufacture of claim 47, wherein the consumer is identified based upon data obtained from at least one of a smart card, a club card, a credit card, a drivers license, a telephone number, a biometric identifier, a verbal identification of the consumer, and written identification of the consumer.

49. The article of manufacture of claim 45, wherein the article of manufacture comprises at least one of a compact disc, DVD, a memory stick, a magnetic disc, magnetic tape, optical disc, memory card, a magnetically readable device, an optically readable device, and a holographically readable device.

50. A computer readable data transmission medium containing a computer readable data structure utilized by a computer to provide an electronic coupon to a consumer for use in a transaction for a good or service, the computer readable data structure comprising:
a specification of at least one good or service; and
a specification of a discount to be applied to each specified good or service;
wherein the computer readable instructions relate to a programming signal.

51. The computer readable data transmission medium of claim 50 wherein the programming signal includes an address identifying a provider of online content related to the programming signal.

52. The computer readable data transmission medium of claim 50, wherein the computer readable data structure is embedded within the programming signal.

53. The computer readable data transmission medium of claim 50, wherein the computer readable data structure is communicated to the consumer separate from the programming signal.

54. The computer readable data transmission medium of claim 50, wherein the computer readable data structure is communicated to the consumer over at least one of a packet switched network and a circuit switched network.

55. The computer readable data transmission medium of claim 50, wherein the computer readable data structure further comprises a specification to provide an indicator signal which indicates to the consumer that an electronic coupon is available.

56. The computer readable data transmission medium of claim 55, wherein the specification to provide an indicator signal further comprises an instruction to generate an indicator signal comprising at least one of a visual indicator, an audible indicator, and a tactile indicator.

57. The computer readable data transmission medium of claim 50, wherein the computer readable data structure further comprises an expiration date identifying when the discount will no longer be available.

58. The computer readable data transmission medium of claim 50, wherein the electronic coupon is customized to the consumer.

59. The computer readable data transmission medium of claim 58, wherein the electronic coupon is customized based upon a user profile.

60. The computer readable data transmission medium of claim 59, wherein the user profile is based upon at least one of a program the consumer is watching or hearing, a Web page the consumer is accessing, demographic information, viewing history, geographic location information, consumer coupon history, and past user purchases.

61. A method for engaging in a commercial transaction in which a cost of at least one good or service in the transaction is reduced by an electronic coupon, comprising
receiving an electronic coupon related to a programming signal from a consumer;
determining whether the electronic coupon should be applied to at least one good or service in the transaction; and
when the electronic coupon should be applied, deducting a value associated with the electronic coupon from the transaction.

62. The method of claim 61, wherein the electronic coupon relates to a programming signal in which at least one address is embedded, the address identifying a provider of online content which relates to the programming signal.

63. The method of claim 61, wherein the consumer receives the electronic coupon while viewing the programming signal.

64. The method of claim 61, wherein prior to receiving the electronic coupon, the consumer is presented with an indicator signal, the indicator signal notifying the consumer that the electronic coupon may be selected by the consumer.

65. The method of claim 61, wherein the electronic coupon is received via a portable coupon device.

66. The method of claim 65, wherein the portable coupon device further comprises at least one of a magnetic card, optical card, wireless smart card, credit card, wireless telephone, personal digital assistant, and a mobile device.

67. The method of claim 65, wherein the portable coupon device further comprises a club card associated with a consumer.

68. The method of claim 67, wherein receiving the electronic coupon further comprises:
obtaining computer usable data from the club card;
identifying a consumer associated with the club card based upon the computer usable data;
accessing a database containing information related to the identified consumer;
determining from the database whether any electronic coupons are available for the consumer; and
retrieving any available electronic coupons from the database.

69. The method of claim 61, wherein the electronic coupon is received from a database.

70. The method of claim 69, wherein the database is provided at at least one of a cable head-end, a backend, an electronic coupon clearance system, and a merchant database.
